(19) United States
(12) Patent Application Publication
(10) Pub. No.: US 2016/0357236 A1
(43) Pub. Date: Dec. 8, 2016

(54) MP3 connection with ereader

(71) Applicant: Michael Moravitz, Fairfax, VA (US)

(72) Inventor: Michael Moravitz, Fairfax, VA (US)

(21) Appl. No.: 14/545,671

(22) Filed: Jun. 5, 2015

(51) Int. Cl. G06F 1/26; G06F 1/16

(52) U.S. Cl. CPC G06F 1/266; G06F 1/1626

(57) ABSTRACT

Connect an MP3 player, using the long end of a USB cable, to an EReader plugged into an electrical socket to enjoy sound while reading.

It should be possible to enjoy sound from an MP3 player while using an EReader plugged into an electrical socket, which would allow longer reading times and would recharge the EReader and MP3 player.

The Kindle and Nook do not currently come with an electrical socket plug in to recharge the device but I sent in a previous patent application to rectify this. In fact, if liner notes are provided with downloadable music in the future (another of my previous patent applications) perhaps connecting an EReader with an MP3 player would allow a listener to read the notes while enjoying the music. The EReader and MP3 player could be sold together in the future, but with standard USB cables and inputs and outputs, there should be minimum compatibility issues. The EReader would have to be engineered to have an USB plugin in which to receive material from an MP3 player and to send electricity to the MP3 player—although if the MP3 player is properly charged it could be used without having the EReader plugged in to the electrical socket. Conversely, the MP3 player could be plugged into the electrical socket, the USB cable to the EReader, and both devices charged and sharing information that way. Software and mechanical engineers would have to adapt EReaders, MP3 players, USB cables, and electrical socket plug ins to work together.

1. My previous patent application for EReader with Electric Plug in (29/463,809—I have petitioned for this application to be changed from a design to a utility patent);

2. Builds on patents for the Nook (Barnes and Noble) and Kindle (Amazon) EReaders;

3. Builds on patents for USB cables;

4. Builds on patents for electrical recharge cables for MP3 devices such as the IPod that can be used for EReaders instead;

5. My previous patent application for Liner Notes from MP3 players (U.S. Ser. No. 14/121,538);

6. Builds on patents for MP3 players, including the IPod (Apple Corporation).
